(19) United States
(12) Patent Application Publication
(10) Pub. No.: US 2012/0049029 A1
(43) Pub. Date: Mar. 1, 2012

(54) SINGLE-PIECE BRACKET FOR AERONAUTICAL EQUIPMENT

(75) Inventor: Michel Henri Ziegler, Vert le Grand (FR)

(73) Assignee: SNECMA, PARIS (FR)

(21) Appl. No.: 13/265,059

(22) PCT Filed: Apr. 22, 2010
(86) PCT No.: PCT/EP10/55381

§ 371 Date: Oct. 18, 2011

(30) Foreign Application Priority Data
Apr. 24, 2009 (FR) 0952686

(51) Int. Cl. F16M 13/00

(52) U.S. Cl. 248/309.1

(57) ABSTRACT

A bracket for auxiliary equipment of a device, such as cables or pipes, includes a single metal plate that has been cut and then folded, forming elbow connections between the console, a support for attaching equipment, a flange for fastening to the device, and two intermediate ribs. The closed, or nearly closed, outline of the bracket and the parallel or convergent ribs form a trapezium and provide satisfactory transmission and satisfactory distribution of the efforts: the bracket is robust although it has been manufactured from quite a thin plate. The bracket, for example, finds application to aeronautics, to support, for example, a supply of electricity and fluids to engines.

The subject of the present invention is a bracket for aeronautical equipment which is made from a single piece.

Aeronautical devices such as turbomachines often include a quantity of auxiliary equipment surrounding them, notably electrical power cables and cables for transmission of signals and commands, and also fluid conveyance pipes, which must be kept close to the device. Elbow brackets are typically used, one side of which is attached to the structure of the device by bolts and the other end of which carries the cables, pipes and other elements by collars, pairs of spring plates or other means. Since these brackets are generally produced by bending metal plates, they are of poor rigidity and they must be reinforced by ribs attached to both sides of the plate by edges. The ribbing is traditionally welded to the plate by a continuous bead or by points, which has the disadvantage that it greatly increases manufacturing times and increases the cost of these brackets.

A fundamental aim of the invention is to offer a bracket for aeronautical equipment which has a simpler structure, in practice consisting of a single plate of folded metal, without any welding, but without its effort resistance being compromised.

In a general form, the invention thus concerns a bracket for aeronautical equipment including a flange connecting to a supporting structure, a console for attaching the equipment and an intermediate reinforcing part, where the flange, the reinforcing part and the console are formed from a single plate of folded metal (hence the single-piece character of the bracket), where the reinforcing part consists of two ribs each extending between the flange and the console, and attached to them by elbow connections, essentially in oblique directions not perpendicular to a principal plane of extension of the flange and to a principal plane of extension of the console, where the console and the flange have no junction other than the ribs, and the ribs are connected either side of the console.

The welded ribs are thus replaced by ribs which are fully incorporated in the remainder of the bracket. As there are two such, one either side of the console, they allow the efforts to be distributed satisfactorily, and therefore give the bracket sufficient robustness. Since the manufacturing operations consist merely of cutting a metal sheet, and folding the bracket blank cut in this manner, it is easy and rapid to manufacture the bracket.

The resistance of the bracket is improved if the ribs are flat and the said principal planes of extension of the flange and of the console are mutually perpendicular.

It may be considered that the resistance of the bracket is generally high if its structure is closed, with the ends of the cut sheet metal blank being attached (without any welding being required at this junction; it is even normally avoided in order to preserve the advantage of simplicity of manufacture). This closure is less useful in the location of the flange, which is firmly held in the equipment with which the bracket is fitted. In such a case the flange may be divided without any disadvantage into two mutually separated portions, which are joined respectively to the ribs. The portions of the flange can then be in directions which diverge from the connections to the ribs.

In another embodiment the ends of the blank of the metal plate are located on the console. In this case there is only one flange and the console is divided into two portions, which converge from the connections to the ribs and are attached by superimposed ends. At this point a weld or another method of close joining of the ends of the plate is normally not used.

The invention will now be described in greater detail by means of the following figures:

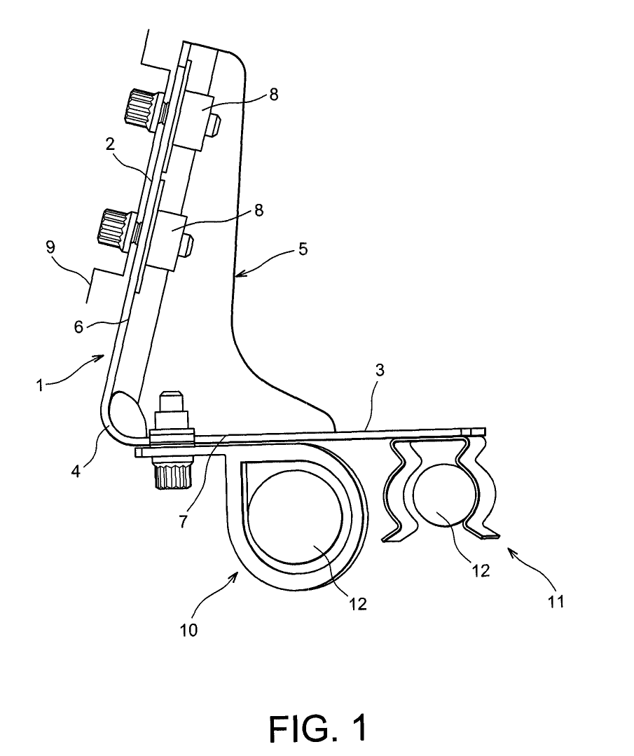

FIG. 1 is a view of a design in accordance with the prior art,

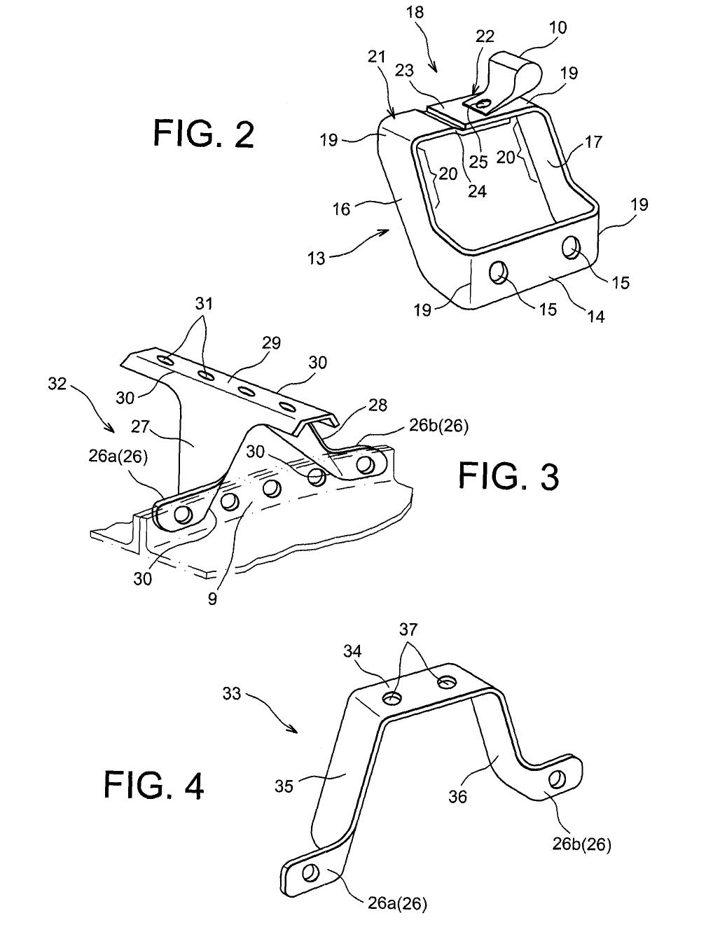

and FIGS. 2, 3 and 4 represent three possible embodiments of the invention.

The bracket of FIG. 1 includes a main plate 1 consisting of a first side 2 and a second side combined with an angle 4 making a square edge or having another angle value. Sides 2 and 3 are still combined by a reinforcing rib 5 which presses on to them by means of two edges, respectively 6 and 7. The connection is made by welds. One of the sides 2 is a flange which includes bolts 8 for attachment to a structure 9 of an aeronautical device, and the second side 3 is a console which carries, in this particular embodiment, a collar 10 and a clamp 11 with two opposing spring plates to hold cables or pipes 12.

The bracket of the invention consists of a single metal plate, 13 in FIG. 2, which is folded after having been cut. It forms a part of flange 14 for the attachment to the structure 9, which is not represented here, and which includes bolt holes 15 for attachment. There is also a pair of ribs 16 and 17, a console 18 supporting the cable and pipe fastening equipment, and also collar 10. Ribs 16 and 17 are each connected to flange 14 and to console 18 by connections 19 which match the folds of the plate. These connections are in this case roughly right-angle elbows, and ribs 16 and 17 are curved through approximately a quarter circle. A bracket is therefore obtained in which flange 14 extends in a vertical plane (according to FIG. 2), console 18 in a horizontal plane, and ribs 16 and 17 in vertical planes perpendicular to the previous ones, with principal portions 20 extending obliquely, but with a slight inclination relative to vertical. Console 18 consists of the ends of the metal plate, which form convergent portions 21 and 22, which overlap at a point of junction 23. The join may be made with or without an indentation 24 of one of the ends 21. Ends 21 and 22 have bolt holes 25 at their ends 23, in order that they may be screwed to each other and also to the collar 10. The planes of ribs 16 and 17 may or may not be parallel, and depending on the case bracket 13 has a general projected rectangular or trapezoid shape, with console 18 and flange 14 of widths which may or may not be equal; it is not critical for the properties of the bracket 13.

This closed-elbow bracket which is shaped like a (hollowed-out) box is particularly rigid even using quite a thin steel plate due, among other things to a satisfactory transmission of the efforts produced on the collar 10 by ribs 15 and 17, which are positioned symmetrically either side of it, or which have a slight overhang relative to the flange 14, due to the slight inclination of their principal portions 20; and the connections 19 are continuous and rounded. The foregoing produces little concentration of stresses, and there is no weak area.

These properties are found in other possible embodiments of the invention, present in FIGS. 3 and 4. Bracket 32 of FIG. 3 includes, as previously, a flange 26, a pair of ribs 27 and 28, and a console 29. These elements are attached to one another by elbow connections 30 in the same way as in FIG. 2, such that ribs 27 and 28 are connected by their ends to flange 26 and to console 29, and such that the latter are separated from one another and have no other connection between them.

These are the main differences relative to the embodiment of FIG. 2. Flange 26 is firstly produced in the form of two tabs 26a and 26b, which are separate from one another and which extend in divergent directions from their connections 30 to respective ribs 27 and 28. The planes of ribs 27 and 28 are no longer perpendicular to that of console 29, but oblique to it such that they converge towards one another, forming an acute angle from tabs 26a and 26b, and where bracket 32 has the general shape of a trapezium. Conversely, there is no obliqueness of ribs 27 and 28 relative to flange 26; they extend upwards besides the plane of flange 26, but do not move away from it. Console 29 is in this case continuous, and there is only one of them. It extends with a great extension in a plane perpendicular to the plane of flange 26 and either side of the latter, preventing the overhang and allowing a larger number of bolt holes 31 than in the previous embodiment. Ribs 27 and 28 are made such that they become larger as they approach console 29, in order better to support it.

Although this embodiment differs greatly externally from the previous one, the favourable properties of the latter are retained, since the ends of the folded plate are simply positioned on flange 26 rather than on console 29. There is no loss of cohesion compared to the previous embodiment, even if bracket 25 no longer has a closed structure, since the structure 9 provides the join between tabs 26a and 26b. And a firm support of console 29 is still obtained if ribs 27 and 28 are not parallel to one another, but convergent. Nor does the principal extension of console 29 in a direction perpendicular to flange 26, rather than parallel to it, as was the case in FIG. 2, impair the bracket's stability, since its average overhang relative to flange 26 is slight.

Another embodiment of a bracket 33 will now be described by means of FIG. 4. It resembles that of FIG. 3, if only in that the console, now 34, extends principally in the same direction as flange 26, and in that the ribs, now 35 and 36, are not made such that they become larger as they approach towards it. This bracket 33, of simple and compact construction, is suitable for supporting a smaller number of elements, if excessive lengthening is to be avoided. It may also include multiple bolt holes 27, aligned for the most part in the direction of extension of flange 26.

Other embodiments are possible.

1-5. (canceled)

6. A bracket for aeronautical equipment, comprising:
a flange for connection to a supporting structure;
a console for attaching equipment; and
an intermediate reinforcing part;
wherein the flange, the reinforcing part, and the console are formed from a single, folded metal plate,
wherein the reinforcing part includes two ribs, each extending between the flange and the console, and attached to it by elbow connections, most of which are in oblique directions that are not perpendicular to a principal plane of extension of the flange or to a principal plane of extension of the console,
wherein the console and the flange have no connection other than the ribs,
wherein the ribs are connected on either side of the console, and
wherein the ribs are flat and principal planes of extension of the flange and of the console are mutually perpendicular.

7. A bracket for aeronautical equipment according to claim 6, wherein the ribs extend in convergent directions, forming an angle other than a straight angle.

8. A bracket for aeronautical equipment according to claim 6, wherein the flange is divided into two portions that are mutually separated and attached respectively to the ribs.

9. A bracket for aeronautical equipment according to claim 8, wherein the portions extend in divergent directions from the connections to the ribs.

10. A bracket for aeronautical equipment according to claim 6, wherein there is only one flange and the console is divided into two convergent portions from the connections to the ribs, and attached by superimposed ends.

11. A bracket for aeronautical equipment according to claim 7, wherein the flange is divided into two portions that are mutually separated and attached respectively to the ribs.

12. A bracket for aeronautical equipment according to claim 7, wherein there is only one flange and the console is divided into two convergent portions from the connections to the ribs, and attached by superimposed ends.
